(19) United States
(12) Patent Application Publication
(10) Pub. No.: US 2013/0325203 A1
(43) Pub. Date: Dec. 5, 2013

(54) METHODS AND SYSTEMS FOR MONITORING A VEHICLE FOR FAULTS

(71) Applicants: TSAI-CHING LU, WYNNEWOOD, PA (US); DAVID L. ALLEN, THOUSAND OAKS, CA (US); YILU ZHANG, NORTHVILLE, MI (US); MUTASIM A. SALMAN, ROCHESTER HILLS, MI (US)

(72) Inventors: TSAI-CHING LU, WYNNEWOOD, PA (US); DAVID L. ALLEN, THOUSAND OAKS, CA (US); YILU ZHANG, NORTHVILLE, MI (US); MUTASIM A. SALMAN, ROCHESTER HILLS, MI (US)

(73) Assignee: GM GLOBAL TECHNOLOGY OPERATIONS LLC, DETROIT, MI (US)

(21) Appl. No.: 13/488,502

(22) Filed: Jun. 5, 2012

(51) Int. Cl. G06F 7/00

(52) U.S. Cl. 701/1

(57) ABSTRACT

Methods and systems are provided for monitoring a vehicle. In one embodiment, the method includes, but is not limited to, receiving traffic data from a vehicle communication bus. The method further includes, but is not limited to, identifying, by a processor, net-motifs from the traffic data. The method still further includes, but is not limited to, detecting a mode of components of the vehicle based on the net-motifs.

### TECHNICAL FIELD

The present disclosure generally relates to methods and systems for diagnosing a vehicle, and more particularly relates to methods and systems for diagnosing faults in a vehicle using net-motifs.

### BACKGROUND

Vehicle technician tools connect to a vehicle's communication system to monitor and retrieve data from the vehicle. The technician tools are most commonly used to aid the technician in diagnosing problems of the vehicle. For example, diagnostic trouble codes can be retrieved from the vehicle's communication system through the technician tool. Due to the large variation in vehicle configurations, a technician must follow through a service diagnostic tree to retrieve the code and determine the fault. Such a method can be time consuming and error prone. In addition, intermittent faults in hardware, software, and communication links can be difficult to identify because they may not always be represented by a code.

Accordingly, it is desirable to provide improved methods and systems for monitoring a vehicle and detecting faults in the vehicle. Furthermore, other desirable features and characteristics of the present invention will become apparent from the subsequent detailed description and the appended claims, taken in conjunction with the accompanying drawings and the foregoing technical field and background.

### SUMMARY

Methods and systems are provided for monitoring a vehicle. In one embodiment, the method includes, but is not limited to, receiving traffic data from a vehicle communication bus. The method further includes, but is not limited to, identifying, by a processor, net-motifs from the traffic data. The method still further includes, but is not limited to, detecting a mode of components of the vehicle based on the net-motifs.

In another embodiment, a system for monitoring a vehicle is provided. The system includes, but is not limited to, a first module that receives traffic data from a vehicle communication bus. The system further includes, but is not limited to, a second module that identifies net-motifs from the traffic data. The system still further includes, but is not limited to, a third module that detects a mode of components of the vehicle based on the net-motifs.

### DESCRIPTION OF THE DRAWINGS

The present invention will hereinafter be described in conjunction with the following figures, wherein like numerals denote like elements, and:

FIGS. 1 and 2 are functional block diagrams illustrating vehicle monitoring systems in accordance with exemplary embodiments;

FIG. 3 is a dataflow diagram illustrating a monitoring module of the vehicle monitoring systems in accordance with exemplary embodiments;

FIGS. 4-6 are diagrams illustrating exemplary message networks and net-motifs that may be generated by the monitoring module in accordance with exemplary embodiments; and

FIG. 7 is a flowchart illustrating a monitoring method that may be performed by the vehicle monitoring systems in accordance with exemplary embodiments.

### DETAILED DESCRIPTION

The following detailed description is merely exemplary in nature and is not intended to limit the invention or the application and uses of the invention. Furthermore, there is no intention to be bound by any expressed or implied theory presented in the preceding technical field, background, brief summary or the following detailed description. It should be understood that throughout the drawings, corresponding reference numerals indicate like or corresponding parts and features. As used herein, the term module refers to any hardware, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality.

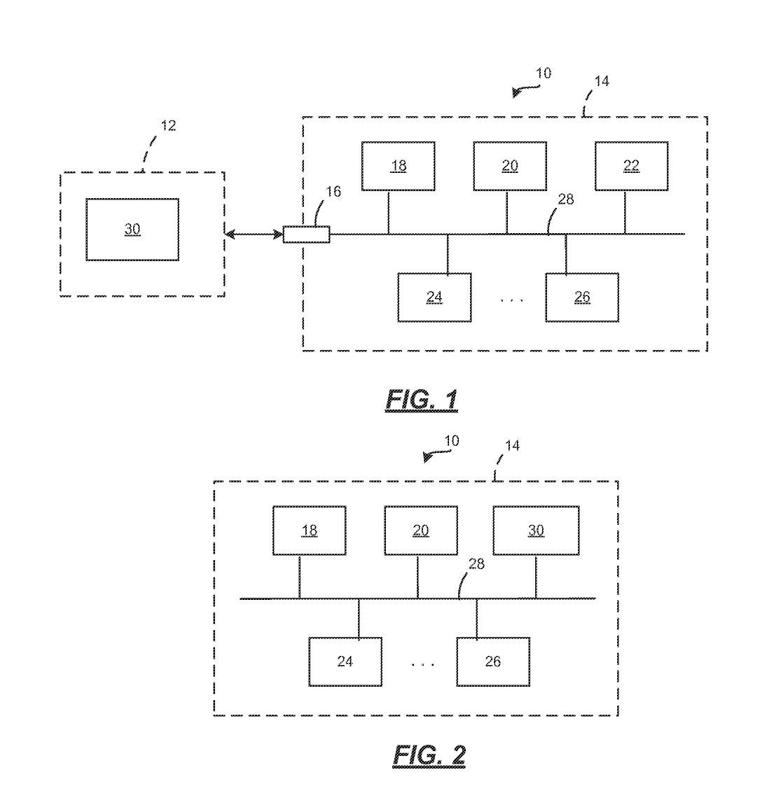

Referring now to FIGS. 1 and 2, a vehicle monitoring system 10 is shown in accordance with various embodiments. Although the figures shown herein depict an example with certain arrangements of elements, additional intervening elements, devices, features, or components may be present in actual embodiments. It should also be understood that FIGS. 1 and 2 are merely illustrative and may not be drawn to scale.

In FIG. 1, the vehicle monitoring system 10 is shown to include a computing device 12 that is associated with a vehicle 14. The computing device 12 communicates with the vehicle 14 through one or more communication devices 16. As can be appreciated, the communication device(s) 16 may be a wired communication device (e.g., a wired connection through an assembly line diagnostic link (ALDL) connector of the vehicle 14 or any other wired system), a wireless communication device (e.g., a wireless connection to a telematics system of the vehicle 14, or any other wireless system), or a combination a wired communication device and a wireless communication device.

The vehicle 14 includes one or more control modules 18-26 that are communicatively coupled via a vehicle communication bus 28. The control modules 18-26 process signals from one or more components (not shown) of the vehicle 14 and/or control one or more components (not shown) of the vehicle 14 (e.g., an engine control module, a transmission control module, a body control module, etc.). The control modules 18-26 communicate messages on the vehicle communication bus 28 based on the processing and/or controlling. The vehicle communication bus 28 may include one or more networks such as a Controller Area Network (CAN) bus, a FlexCAN bus, a Local Interconnect Network (LIN) bus, a GMLAN bus, and/or a FlexRay bus. However, other networks besides those commonly found in automotive environments may also be used.

The computing device 12 can be any computing device including, but not limited to, a laptop computer (as shown), a handheld device (such as a technician tool), a desktop computer, a workstation, or any other device that includes a data storage device and a processor. The processor can be, for example, any custom made or commercially available processor, a central processing unit, an auxiliary processor among several processors associated with the computer, a semiconductor based microprocessor, a macroprocessor, or generally any device for executing instructions. The data storage device can be, for example, at least one of the random access memory, read only memory, a cash, a stack, or the like which may temporarily or permanently store electronic data. As can be appreciated, the computing device 12, in various embodiments, can be a single computing device (as shown) or a combination of computing devices that communicate data using one or more defined communication protocols.

The computing device 12 includes a monitoring module 30 in accordance with exemplary embodiments. The monitoring module 30 processes traffic data on the vehicle communication bus 28 to differentiate failure modes within the vehicle 14. The monitoring module 30 processes the traffic data by establishing traffic patterns and evaluating the traffic patterns to determine a particular failure mode. The failure mode may be due to a software failure (i.e., failure of the software logic in a control module 18-26), or a hardware failure such as a wiring failure (i.e., faulty wires (not shown) connected to the control modules 18-26 and/or the vehicle communication bus 28), or a connector failure (i.e., faulty connectors (not shown) between the wires and the control modules 18-26 and/or the vehicle communication bus 28). The monitoring module 30 then presents the failure mode and other failure information to a service technician or product developer through a graphical or textual user interface.

In FIG. 2, the vehicle monitoring system 10 is shown to include a vehicle 14 that includes the monitoring module 30 in accordance with exemplary embodiments. That is, rather than having the monitoring module 30 be implemented on a separate computing device 12 as in FIG. 1, the monitoring module 30 is implemented as part of the vehicle 14. In this embodiment, the monitoring module 30 can be a stand-alone module that communicates with the other control modules 18-26 over the vehicle communication bus 28, can be implemented as part of one of the control modules 18-26, or can be partly implemented as a stand-alone module and partly implemented on one of the control modules 18-26. In this embodiment, the monitoring module 30 processes the data traffic in real-time and presents the failure mode to an operator of the vehicle 14 through a visual signal (e.g., via a warning lamp), an audio signal (e.g., via a warning chime), a data signal (e.g., via a data display such as a navigation system or other interface), or a combination thereof.

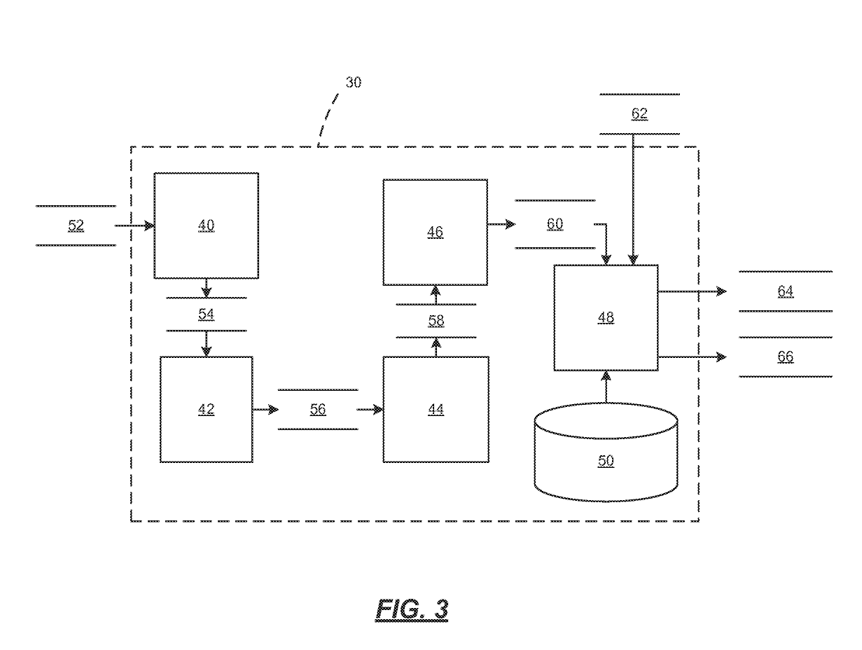

Referring now to FIG. 3 and with continued reference to FIGS. 1 and 2, a dataflow diagram illustrates various embodiments of the monitoring module 30 of the vehicle monitoring system 10. Various embodiments of monitoring modules 30 according to the present disclosure may include any number of sub-modules. As can be appreciated, the sub-modules shown in FIG. 3 may be combined and/or further partitioned to similarly monitor traffic data of the vehicle 14. Inputs to the monitoring module 30 may be received from user input, retrieved from a data storage device, and/or received from the vehicle communication bus 28. In various embodiments, the monitoring module 30 includes a data collection module 40, a message network constructor module 42, a net-motif identification module 44, a motif distribution determination module 46, a fault mode detection module 48, and a motif distribution vector datastore 50.

The data collection module 40 receives as input traffic data 52 from the vehicle communication bus 28. The traffic data 52 includes messages that have been communicated between the control modules 18-26 and/or information about the communication of messages between the control modules 18-26 on the vehicle communication bus 28. As can be appreciated, depending on the implementation of the monitoring module 30 (e.g., on the computing device 12 associated with the vehicle 14, or as a module of the vehicle 14) the traffic data 52 can be received based on a request initiated by the data collection module 30 and/or based on a scheduled event to retrieve the traffic data 52 from the vehicle communication bus 28. The data collection module 40 may optionally format and/or store the traffic data 52 for further processing.

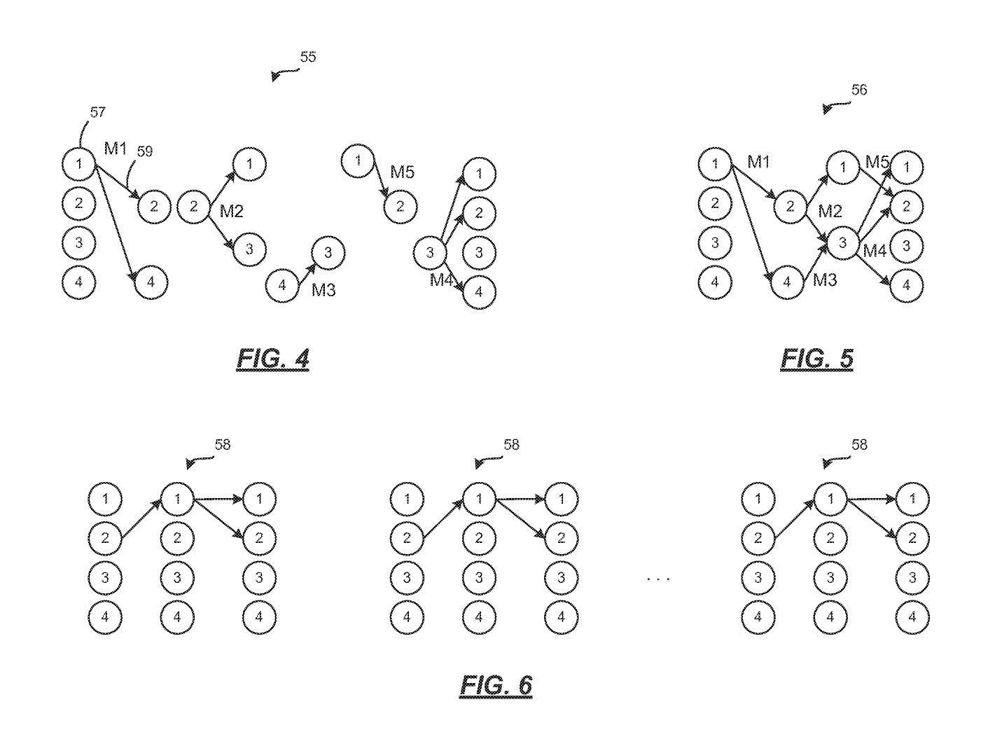

The message network constructor module 42 receives as input the stored/formatted traffic data 54. The message network constructor module 42 constructs a message network 56 from the traffic data 54. As shown in FIGS. 4 and 5, the message network 56 includes nodes 57 that represent the control modules 18-26 of the vehicle 14 and edges 59 that represent the communication of one or more messages (M1-M5) between the control modules 18-26.

When constructing the message network 56, the message network constructor module 42 evaluates each message (M1-M5), constructs a direct mapping 55 of the messages (M1-M5) between control modules 18-26 and then from the direct mapping 55, constructs the message network 56. As can be appreciated, the message network constructor module 42 may construct the message network 56 using various network construction methods. In one exemplary embodiment, the following method may be used to construct the direct mapping 55 and the message network 56:

INITIALIZE discrete counter T=1
FOR EACH MESSAGE [ECUᵢ −> ECU_{j, k, ...}]

LET tₜₓ = T
IF the sender of the current message is found as a receive-only node
(with only incoming edges) within the previous W seconds, counted
from the current message timestamp (simulation or real time values)

SET tₜₓ equal to the counter value associated with ECUᵢ; change
ECUᵢ to transmit node from receive-only node

ELSE

CREATE a new ECUᵢ transmit node and associated it with the
counter value tₜₓ

CREATE receive nodes ECU_{j, k, ...} if they do not already exist at the
counter value tₜₓ+1 (note this may not be T+1 if used previous
receive node)
ADD edges from associated ECUᵢ −> ECU_{j, k, ...} node
SET T = tₜₓ+1 (the receive node's counter value of the current
message).

The net-motif identification module 44 receives as input the message network 56. Based on the message network 56, the net-motif identification module 58 identifies net-motifs 58. As shown in FIG. 6, the net-motifs 58 include sub-graph patterns from the message network 56 with a fixed length. As can be appreciated, the net-motif identification module 44 may identify the net-motifs 58 using various motif identification methods. In one exemplary embodiment, the following method may be performed by the net-motif identification module 44 to identify the net-motifs 58:

ASSIGN nodes of input graphs with ordered indices,
ASSOCIATE each node in a RT with two sub-graphs sets (Vsub) and

each exclusive neighbors (Vecn) (with the exception of the root
node),

LABEL nodes in Vsub as spawning nodes and nodes in Vecn are

nodes with indices greater than the associated spawning nodes in
Vsub, and

RECURSIVELY GROW the RT to the k-level (which would be the

sub-graph with size k).

The motif distribution determination module 46 receives as input the net-motifs 58. Based on the net-motifs 58, the motif distribution determination module 46 computes motif distributions vectors 60. For example, a motif distribution vector 60 can be computed for each net-motif 48 by counting the number of occurrences of that net-motif 48 and normalizing by the total number of occurrences. The motif distribution vectors 60 represent the probability that the net-motif is present in the message network 56.

The fault mode detection module 48 receives as input the motif distribution vectors 60 and topological data 62. The topological data 62 includes information on the topology of the vehicle 14. The fault mode detection module 48 detects and reports a particular fault mode 64 or a normal mode 66 by comparing the determined motif distribution vectors 60 with other motif distribution vectors. The other motif distribution vectors may be motif distribution vectors that represent known failure modes or distribution vectors that represent known normal modes. The other motif distribution vectors may be predetermined by performing the same methods as discussed above on known faulty systems or known normal systems and stored in the motif distribution vector datastore 50 for the comparison. The fault mode 64 and the normal mode 66 can then be used to generate the reporting signals. The fault mode detection module 48 may associate the particular fault mode 64 or normal mode 66 with a particular component (e.g., hardware or software) of the vehicle based on the topological data 62.

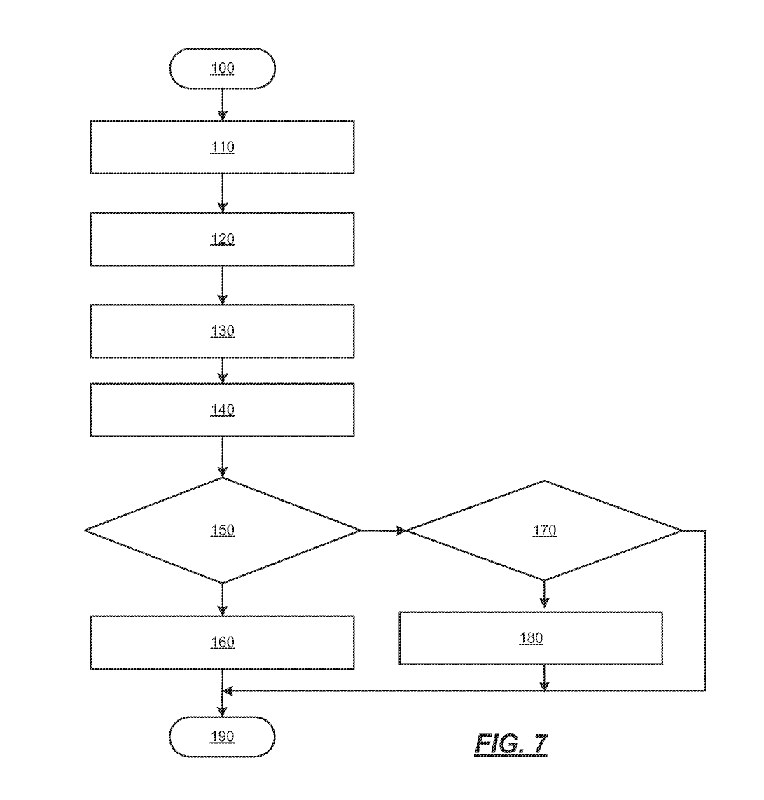

Referring now to FIG. 7, and with continued reference to FIGS. 1 through 3, a flowchart illustrates a monitoring method that can be performed by the monitoring module 30 of FIGS. 1 and 2 in accordance with the present disclosure. As can be appreciated in light of the disclosure, the order of operation within the method is not limited to the sequential execution as illustrated in FIG. 7, but may be performed in one or more varying orders as applicable and in accordance with the present disclosure. As can further be appreciated, one or more steps of the method may be added or deleted without altering the spirit of the method.

In one example, the method may begin at 100. The traffic data 52 is received and stored at 110. The message network 56 is constructed by evaluating the stored traffic data 54 at 120, for example, using the methods described above. The net-motifs 58 are identified at 130, for example, using the methods described above. The motif distribution vectors 60 are computed at 140 and compared with predetermined motif distribution vectors at 150. If the motif distribution vector 60 is the same as or similar to a predetermined motif distribution that represents a fault at 150, then the fault mode 64 is reported by generating a warning signal and/or a fault message that is presented graphically and/or textually at 160. Using the topological data 62, the fault message includes an indication of whether the fault is associated with software, communication, or hardware. Thereafter, the method may end at 190.

If, however, the motif distribution vector 60 does not match a predetermined motif distribution that represents a fault at 150, rather the motif distribution vector 60 is the same or similar to a predetermined motif distribution that represents normal operation at 170, the normal operation mode 66 is reported at 180, similar to step 160. Thereafter, the method may end at 190.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method of monitoring a vehicle, comprising:
receiving traffic data from a vehicle communication bus;
identifying, by a processor, net-motifs from the traffic data; and
detecting a mode of components of the vehicle based on the net-motifs.

2. The method of claim 1 further comprising constructing a message network based on the traffic data, and wherein the identifying the net-motifs is based on the message network.

3. The method of claim 1 further comprising computing motif distribution vectors based on the net-motifs, and wherein the detecting the mode is based on the motif distribution vectors.

4. The method of claim 3 further comprising comparing the motif distribution vectors with predetermined motif distribution vectors, and wherein the detecting the mode is based on the comparing.

5. The method of claim 4 wherein the predetermined motif distribution vectors represent at least one of a normal mode of operation and a faulty mode of operation.

6. The method of claim 1 wherein the detecting the mode further comprises detecting at least one of a fault mode and a normal mode.

7. The method of claim 6 wherein the detecting the mode further comprises detecting a mode of software or hardware of the vehicle.

8. The method of claim 7 further comprising associating the mode with a particular software or a particular hardware of the vehicle based on topological data of the vehicle.

9. A system for monitoring a vehicle, comprising:
a first module that receives traffic data from a vehicle communication bus;
a second module that identifies net-motifs from the traffic data; and
a third module that detects a mode of components of the vehicle based on the net-motifs.

10. The system of claim 9 further comprising a fourth module that constructs a message network based on the traffic data, and wherein the second module identifies the net-motifs based on the message network.

11. The system of claim 9 further comprising a fifth module that computes motif distribution vectors based on the net-motifs, and wherein the third module detects the mode based on the motif distribution vectors.

12. The system of claim 11 wherein the third module compares the motif distribution vectors with predetermined motif distribution vectors, and detects the mode based on the comparing.

13. The system of claim 12 wherein the predetermined motif distribution vectors represent at least one of a normal mode of operation and a faulty mode of operation.

14. The system of claim 9 wherein the third module detects the mode by detecting at least one of a fault mode and a normal mode.

15. The system of claim 14 wherein the third module detects the mode by detecting a mode of software or hardware of the vehicle.

16. The system of claim 15 wherein the third module associates the mode with a particular software or a particular hardware component of the vehicle based on topological data of the vehicle.

17. The system of claim 9 wherein the first module, the second module, and the third module reside on the vehicle.

18. The system of claim 9 further comprising a computing device, and wherein the first module, the second module, and the third module reside on the computing device.
